(19) United States
(12) Patent Application Publication
(10) Pub. No.: US 2026/0123782 A1
(43) Pub. Date: May 7, 2026

(54) JUICE DISCHARGING BUCKET STRUCTURE OF A FOOD PROCESSING MACHINE

(71) Applicant: Foshan Shunde Yi Mingjia Plastic Co.,Ltd., Foshan (CN)

(72) Inventor: Jianbo HE, Foshan (CN)

(21) Appl. No.: 19/436,637

(22) Filed: Dec. 30, 2025

Related U.S. Application Data
(63) Continuation of application No. PCT/CN2024/131672, filed on Nov. 13, 2024.

(30) Foreign Application Priority Data
Jul. 31, 2024 (CN) 202411043316.9

(51) Int. Cl. A47J 19/02; A47J 19/06

(52) U.S. Cl. CPC A47J 19/025; A47J 19/06

(57) ABSTRACT

The present invention discloses a juice discharging bucket structure of a food processing machine and, for the juice discharging bucket structure of food processing machine, the slag discharging pipe can be opened through flipping, characterized by simple cleaning and high cleanliness; moreover, in the process of flipping slag discharging pipe, the pushing part pushes the transmission shaft, so that the screw rod and the transmission shaft move upward to become loose, convenient for users to take down the screw rod from the juice discharging bucket for cleaning.

### CROSS-REFERENCE TO RELATED APPLICATIONS

This application is a continuation of International Application No. PCT/CN2024/131672, filed on Nov. 13, 2024, which claims priority to Chinese Patent Application No. 202411043316.9, filed with the China National Intellectual Property Administration on Jul. 31, 2024, both of which are hereby incorporated by reference in their entireties.

### TECHNICAL FIELD

The present invention relates to the technical field of food processing machines, particularly to a juice discharging bucket structure of a food processing machine.

### BACKGROUND

The juice discharging bucket of the existing food processing machine, as described in Chinese utility model patent number 2021231549256, titled “a juice discharging bucket with improved structure of a food processing machine”, with authorization announcement date being May 27, 2022, includes a juice discharging bucket and a trigger rod, and the juice discharging bucket has a through-hole, and the trigger rod provided with a touch end is movably disposed on the juice discharging bucket, and the touch end passes through and extends out of the through-hole, and in further the trigger rod also includes an elastic reset member, and a pressure arm extends from the trigger rod, and one end of the elastic reset member is pressed against the juice discharging bucket, and the other end is pressed against the pressure arm; The juice discharging bucket of food processing machine has an improved structure and, due to the extension of the trigger rod into the pressure arm and the use of pressure arm to press against the elastic reset member, the elastic reset member is located on one side of the trigger rod, so that the elastic reset member is not directly placed on the touch end of the trigger rod, without affecting the size of the through-hole through which the touch end passes. A larger outer diameter can be selected, according to needs, for the space where the elastic reset member is located, ensuring that the through-hole size remains unchanged and significantly improving the reset effect.

However, the juice discharging bucket of above-mentioned structure still has the following shortcomings: (1) After use, the slag discharging channel inside the slag discharging pipe is prone to adhering a large amount of food residue, and since the slag discharging pipe is integrated with the juice discharging bucket, specialized tools need to be used, when cleaning is required, to clean the inside of the slag discharging pipe, causing the cleaning more complicated and difficult; (2) The screw and its transmission shaft are firmly installed on the juice discharging bucket, and the users who intend to clean the screw need to first remove the feeding hopper, and then remove the transmission shaft on the screw for cleaning, which is is a rather laborious process.

### SUMMARY

The purpose of the present invention is to solve the shortcomings of prior art and provide a juice discharging bucket structure of a food processing machine that is convenient for cleaning the slag discharging pipe and has high cleaning cleanliness, while also making it easy for users to remove the screw rod.

The purpose of the present invention is achieved as follows:

A juice discharging bucket structure of a food processing machine, comprising a juice discharging bucket, a filter screen, and a screw rod, the juice discharging bucket is provided with a juice discharging chamber, a slag outlet and a juice outlet connected to the juice discharging chamber, the bottom of the juice discharging bucket is also provided with a through-hole connected to the juice discharging chamber, the screw rod is placed inside the filter screen and disposed together in the juice discharging chamber, and one end of the transmission shaft on the screw rod passes downward through the through-hole, and the juice discharging bucket structure also includes a slag discharging pipe, one end of the slag discharging pipe adjacent to the through-hole is provided with a slag inlet, a rotating part, and a pushing part, and the other end of the slag discharging pipe is provided with a slag outlet, the rotating part is rotatably connected to the bottom of the juice discharging bucket, the slag inlet is connected to the slag outlet, and the pushing part is disposed adjacent to one end of the transmission shaft; the juice discharging bucket structure of food processing machine has a slag discharging pipe that is rotatably connected to the juice barrel through a rotating part, and when the slag discharging pipe needs to be cleaned, the slag discharging pipe can be simply opened through flipping, and can be cleaned without the use of specialized tools, characterized by simple cleaning and high cleanliness; moreover, in the process of flipping slag discharging pipe, the pushing part pushes the transmission shaft, so that the screw rod and the transmission shaft move upward to become loose, convenient for users to take down the screw rod from the juice discharging bucket for cleaning.

The purpose of the present invention can also be addressed by the following technical measures:

Specifically, in further, a pushing block extends outward from one end of the slag discharging pipe to form the pushing part, an arc-shaped avoidance part corresponding to the outer circumference of the transmission shaft is provided on the pushing block and is close to the outer circumference of the transmission shaft; the arc-shaped avoidance part provides avoidance space for the pushing block, so that the pushing block will not affect the normal connection between the transmission shaft and the external transmission mechanism, and moreover, can also effectively push the transmission shaft and screw to move when the slag discharging pipe is moving.

Specifically, in further, the pushing block is provided with a rotating part, the slag inlet is located on one side of the pushing block, and the slag outlet is located on one side of the through-hole, the rotating part is connected to the bottom of the juice discharging bucket located on the outer circumference of the through-hole, and the rotating part is located between the slag outlet and the through-hole, ensuring that the slag inlet corresponds to the slag outlet, the pushing part corresponds to the transmission shaft located on the through-hole, and the rotating part is located between the slag outlet and the through-hole, so that the rotating part is adjacent to the slag inlet and the pushing block, with a compact structure, and the slag outlet is adjacent to the through hole, with a compact structure, providing an ideal he implementation effect.

Specifically, in further, the juice discharging bucket structure of a food processing machine further comprises a shaft fixing assembly, the rotating part is a shaft, the shaft fixing assembly is connected to the bottom of the juice discharging bucket adjacent to the through-hole, the shaft fixing assembly is provided with two shaft holes, and the two ends of the shaft extend into the corresponding shaft holes, respectively; the shaft and shaft hole feature simple structure, easy implementation, and their cooperation is so simple and convenient that users can operate conveniently.

Specifically, in further, the shaft fixing assembly comprises an upper fixing part and a lower fixing part, the upper fixing part is provided with two upper notches, and the lower fixing part is provided with two lower notches, the lower fixing part is fixed at the bottom of the juice discharging bucket adjacent to the through-hole, the upper fixing part is fixed on the lower fixing part, and the upper fixing part and lower fixing part together form the shaft hole, which is more conducive to the rotation of the shaft.

Specifically, in further, a connecting column with a connecting screw hole is provided on the juice discharging bucket adjacent to the through-hole, a lower through-hole is opened at a position, corresponding to the connecting screw hole, on the lower fixing part, an upper through-hole is opened at a position, corresponding to the lower through-hole, on the upper fixing part, and a connecting screw sequentially passing through the upper through-hole and lower through-hole is connected to the connecting screw hole, so that the upper and lower fixing parts can be stably connected to the juice discharging bucket through connecting screws.

Specifically, in further, a first buckle part is further provided on the slag discharging pipe and the first buckle part is located between the slag inlet and the slag outlet, and a second buckle part is provided at a position, corresponding to the first buckle part, on the bottom of the juice discharging bucket, and the first buckle part is snap-fitted with the second buckle part; the combination of the first buckle and the second buckle can fix or open the slag discharging pipe on the juice discharging bucket, with a simple structure and easy operation.

Specifically, in further, a first block is provided on the slag discharging pipe, the first block forms the first buckle part, the juice discharging bucket is provided with a detachable buckle base, a second block is provided on the buckle base to form the second buckle part, and the ends of the first block and second block, where the first block abuts against the second block, are an arc-shaped surface; the mutually-fitted curved surfaces not only facilitate users to flip and open the slag discharging pipe, but also ensure the stability of the first and second blocks. In addition, the detachable buckle seat allows users to replace with the compatible buckle base and second buckle part according to the slag discharging pipe and first buckle part of different sizes.

Specifically, in further, the juice discharging bucket structure of a food processing machine further comprises a sealing part, a sealing part groove is provided adjacent to the slag inlet of slag discharging pipe, the sealing part is embedded in the sealing part groove and abuts against the periphery of the slag outlet of juice discharging bucket, in order to prevent the juice from leaking out of the slag outlet and improve the sealing performance of the slag outlet.

Specifically, in further, the sealing part is a silicone part comprising a middle blocking block and a surrounding block, the surrounding block is disposed around the middle blocking block, a gap is provided between the surrounding block and the middle blocking block, the surrounding block is embedded in the sealing part groove, and the middle blocking block abuts against the slag outlet; a silicone sealing part facilitates the pushing of food residue on the slag outlet to the middle blocking block, so that the food residue can enter the slag discharging pipe and ultimately be discharged through the slag outlet of the slag discharging pipe; at the same time, the sealing part is stably installed on the sealing part groove through the surrounding block, and the gap is conducive to the independent and stable operation of the surrounding block and the middle blocking block.

The present invention has the following beneficial effects:

For the juice discharging bucket structure of food processing machine, the slag discharging pipe can be opened through flipping, characterized by simple cleaning and high cleanliness; moreover, in the process of flipping slag discharging pipe, the pushing part pushes the transmission shaft, so that the screw and the transmission shaft move upward to become loose, convenient for users to take down the screw from the juice discharging bucket for cleaning; moreover, in the process of flipping slag discharging pipe, the pushing part pushes the transmission shaft, so that the screw rod and the transmission shaft move upward to become loose, convenient for users to take down the screw rod from the juice discharging bucket for cleaning.
(1) The arc-shaped avoidance part provides avoidance space for the pushing block, so that the pushing block will not affect the normal connection between the transmission shaft and the external transmission mechanism, and moreover, can also effectively push the transmission shaft and screw to move when the slag discharging pipe is moving.
(2) Ensure that the slag inlet corresponds to the slag outlet, the pushing part corresponds to the transmission shaft located on the through-hole, and the rotating part is located between the slag outlet and the through-hole, so that the rotating part is adjacent to the slag inlet and the pushing block, with a compact structure, and the slag outlet is adjacent to the through hole, with a compact structure, providing an ideal he implementation effect.

### BRIEF DESCRIPTION OF THE DRAWINGS

FIG. 1 is a schematic diagram of the juice discharging bucket structure of a food processing machine of the present invention.

FIG. 2 is a schematic diagram of the slag discharging pipe of the present invention in an open state.

FIG. 3 is a disassembled diagram of the juice discharging bucket structure of a food processing machine of the present invention.

FIG. 4 is a sectional view of the juice discharging bucket structure of a food processing machine of the present invention.

FIG. 5 is a sectional view of the juice discharging bucket with filter screen and screw rod removed.

FIG. 6 is a sectional view of FIG. 5 from another angle.

FIG. 7 is an enlarged three-dimensional view of the slag discharging pipe of the present invention.

FIG. 8 is an enlarged three-dimensional view of the sealing part of the present invention.

FIG. 9 is an enlarged three-dimensional view of the upper fixing part of the present invention.

FIG. 10 is an enlarged three-dimensional view of the lower fixing part of the present invention.

### DESCRIPTION OF EMBODIMENTS

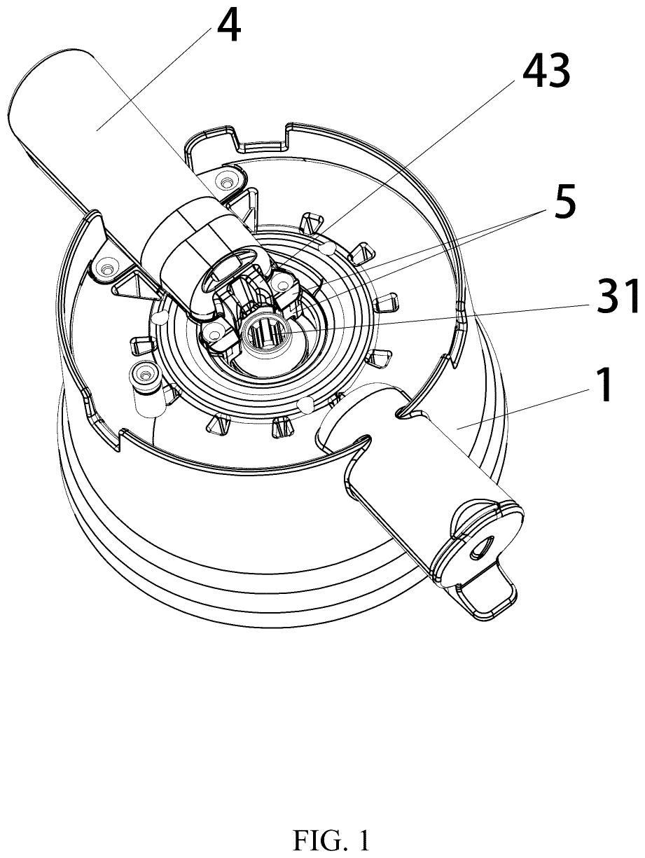

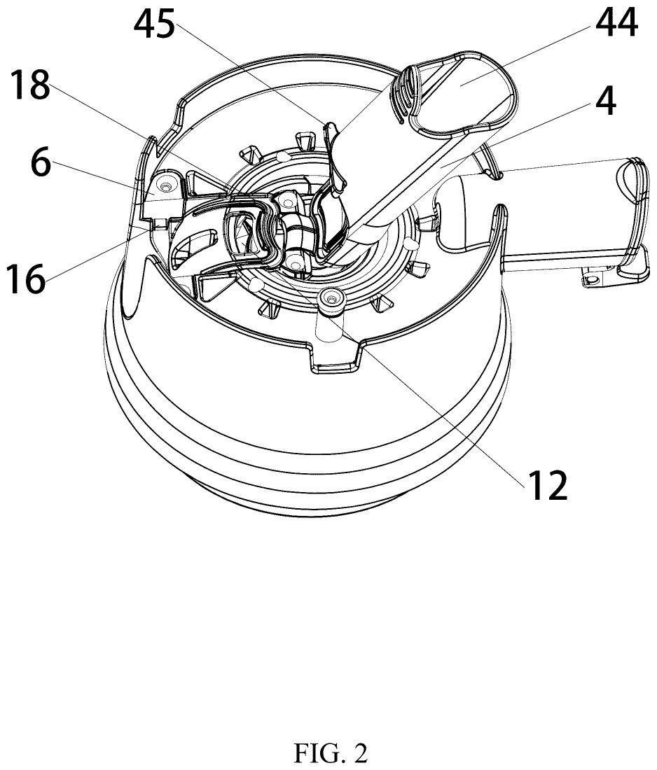

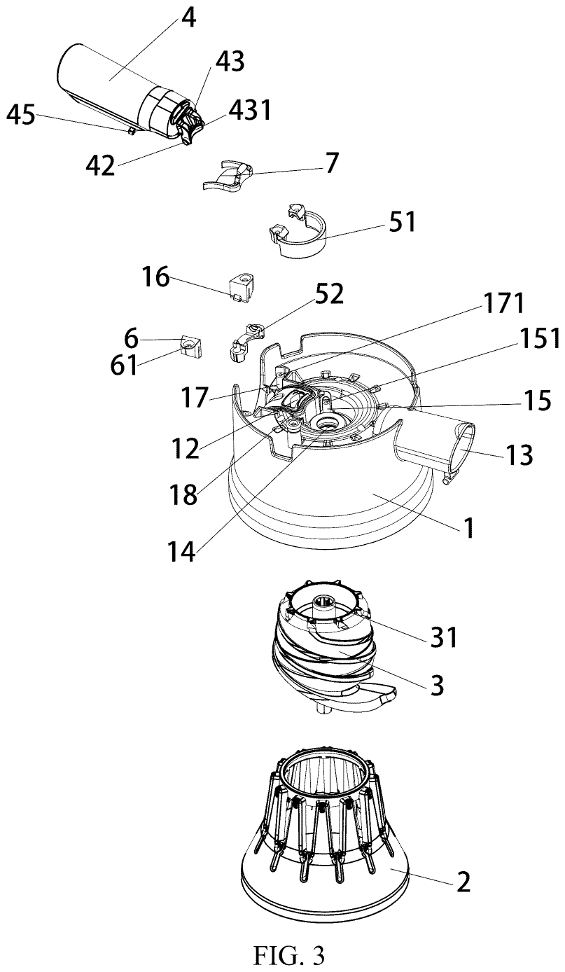

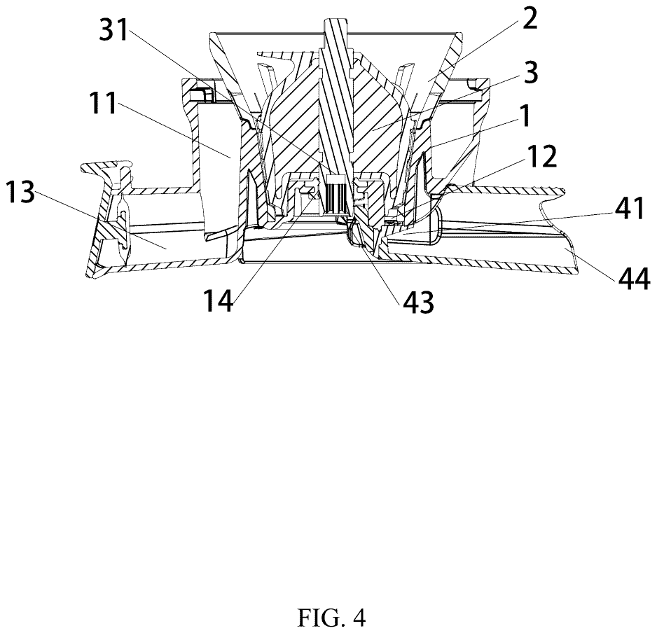

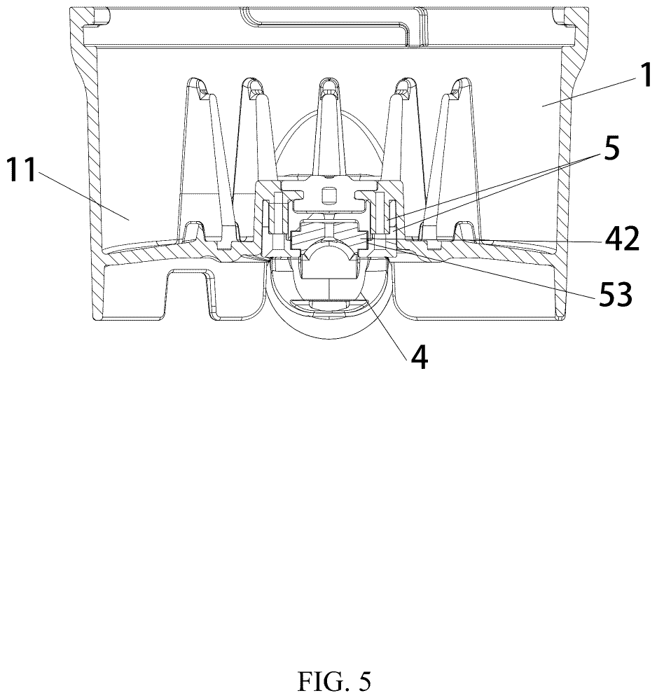

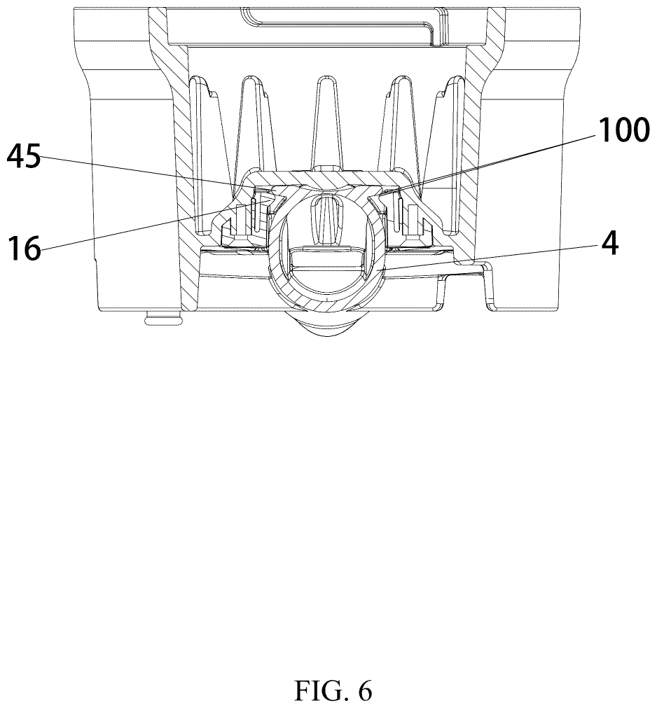

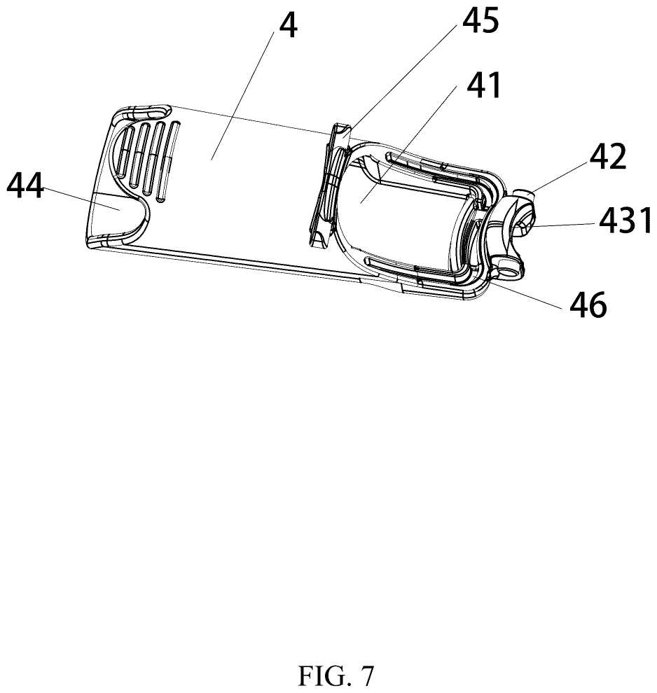

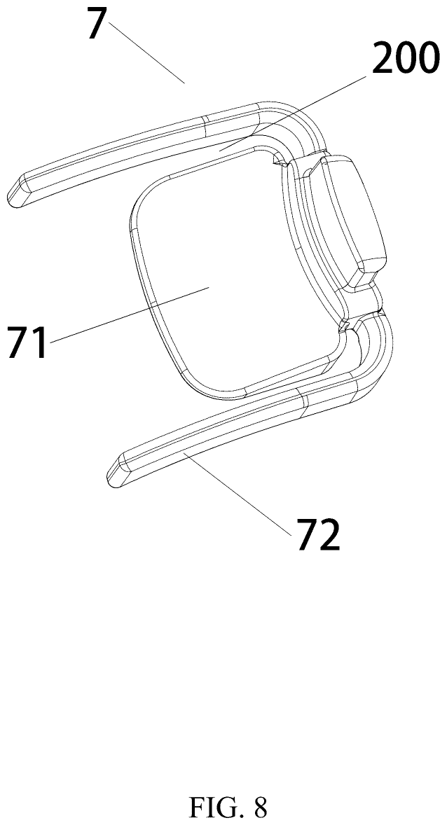

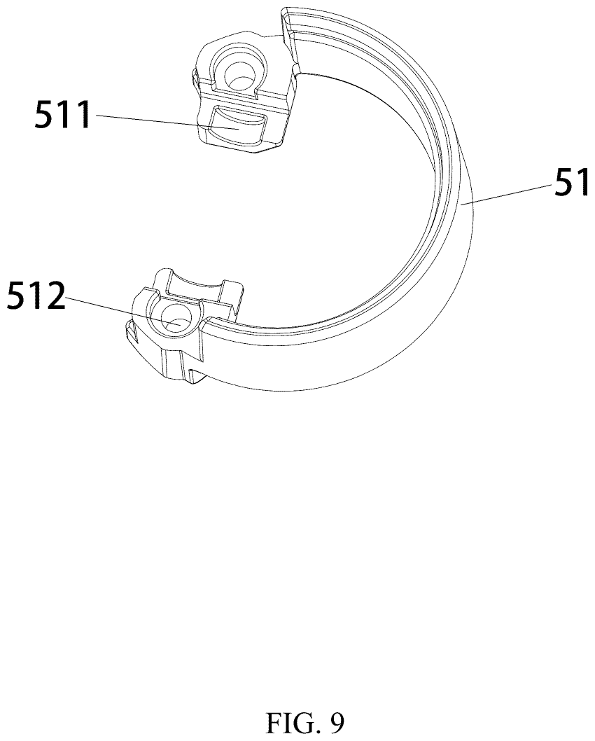

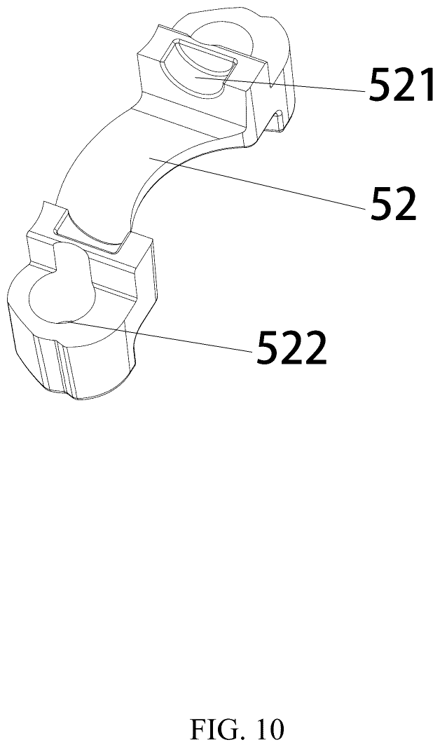

The present invention will be further described below in conjunction with the accompanying drawings and embodiments In the embodiment, as shown in FIG. 1 to FIG. 10, a juice discharging bucket structure of a food processing machine, comprises a juice discharging bucket 1, a filter screen 2, and a screw rod 3, the juice discharging bucket 1 is provided with a juice discharging chamber 11, a slag outlet 12 and a juice outlet 13 connected to the juice discharging chamber 11, the bottom of the juice discharging bucket 1 is also provided with a through-hole 14 connected to the juice discharging chamber 11, the screw rod 3 is placed inside the filter screen 2 and disposed together in the juice discharging chamber 11, and one end of the transmission shaft 31 on the screw rod 3 passes downward through the through-hole 14, and the juice discharging bucket structure also includes a slag discharging pipe 4, one end of the slag discharging pipe 4 adjacent to the through-hole 14 is provided with a slag inlet 41, a rotating part 42, and a pushing part 43, and the other end of the slag discharging pipe 4 is provided with a slag outlet 44, the rotating part 42 is rotatably connected to the bottom of the juice discharging bucket 1, the slag inlet 41 is connected to the slag outlet 12, and the pushing part 43 is disposed adjacent to one end of the transmission shaft 31.

As a more specific solution, a pushing block extends outward from one end of the slag discharging pipe 4 to form the pushing part 43, an arc-shaped avoidance part 431 corresponding to the outer circumference of the transmission shaft 31 is provided on the pushing block and is close to the outer circumference of the transmission shaft 31.

In the embodiment, the pushing block is provided with a rotating part 42, the slag inlet 41 is located on one side of the pushing block, and the slag outlet 12 is located on one side of the through-hole 14, the rotating part 42 is connected to the bottom of the juice discharging bucket 1 located on the outer circumference of the through-hole 14, and the rotating part 42 is located between the slag outlet 12 and the through-hole 14.

As a more specific solution, the juice discharging bucket structure of a food processing machine further comprises a shaft fixing assembly 5, wherein the rotating part 42 is a shaft, the shaft fixing assembly 5 is connected to the bottom of the juice discharging bucket 1 adjacent to the through-hole 14, the shaft fixing assembly 5 is provided with two shaft holes 53, and the two ends of the shaft extend into the corresponding shaft holes 53, respectively.

In the embodiment, the shaft fixing assembly 5 comprises an upper fixing part 51 and a lower fixing part 52, the upper fixing part 51 is provided with two upper notches 511, and the lower fixing part 52 is provided with two lower notches 521, the lower fixing part 52 is fixed at the bottom of the juice discharging bucket 1 adjacent to the through-hole 14, the upper fixing part 51 is fixed on the lower fixing part 52, and the upper fixing part 51 and lower fixing part 52 together form the shaft hole 53.

In the embodiment, a connecting column 15 with a connecting screw hole 151 is provided on the juice discharging bucket 1 adjacent to the through-hole 14, a lower through-hole 522 is opened at a position, corresponding to the connecting screw hole 151, on the lower fixing part 52, an upper through-hole 512 is opened at a position, corresponding to the lower through-hole 522, on the upper fixing part 51, and a connecting screw sequentially passing through the upper through-hole 512 and lower through-hole 522 is connected to the connecting screw hole 151 that is not shown in the figures.

As a more specific solution, a first buckle part 45 is further provided on the slag discharging pipe 4 and the first buckle part 45 is located between the slag inlet 41 and the slag outlet 44, and a second buckle part 16 is provided at a position, corresponding to the first buckle part 45, on the bottom of the juice discharging bucket 1, and the first buckle part 45 is snap-fitted with the second buckle part 16.

In the embodiment, a first block is provided on the slag discharging pipe 4, the first block forms the first buckle part 45, the juice discharging bucket 1 is provided with a detachable buckle base 6, a second block is provided on the buckle base 6 to form the second buckle part 16, and the ends of the first block and second block, where the first block abuts against the second block, are an arc-shaped surface 100.

In the embodiment, a fixing column 17 with a fixing hole 171 is provided on the juice discharging bucket 1, a connecting through-hole 61 is opened at a position, corresponding to the fixing hole 61, on the buckle base 6, and a connecting screw passing through the connecting through-hole 61 is connected to the fixing hole, and the connecting screw is not shown in the figures.

As a better implementation solution, the juice discharging bucket structure of a food processing machine further comprises a sealing part 7, a sealing part groove 46 is provided adjacent to the slag inlet 41 of slag discharging pipe 4, the sealing part 7 is embedded in the sealing part groove 46 and abuts against the periphery of the slag outlet 12 of juice discharging bucket 1.

In the embodiment, the sealing part 7 is a silicone part comprising a middle blocking block 71 and a surrounding block 72, the surrounding block 72 is disposed around the middle blocking block 71, a gap 200 is provided between the surrounding block 72 and the middle blocking block 71, the surrounding block 72 is embedded in the sealing part groove 46, and the middle blocking block 71 abuts against the slag outlet 12.

In the embodiment, a convex surrounding wall 18 is provided next to the slag outlet 12 of the juice discharging bucket 1, and the surrounding block 72 of the sealing part 7 abuts against the upper part of the convex surrounding wall 18.

What is claimed is:

1. A juice discharging bucket structure of a food processing machine, comprising a juice discharging bucket, a filter screen, and a screw rod, the juice discharging bucket is provided with a juice discharging chamber, a slag outlet and a juice outlet connected to the juice discharging chamber, the bottom of the juice discharging bucket is also provided with a through-hole connected to the juice discharging chamber, the screw rod is placed inside the filter screen and disposed together in the juice discharging chamber, and one end of the transmission shaft on the screw rod passes downward through the through-hole, and the juice discharging bucket structure also includes a slag discharging pipe, one end of the slag discharging pipe adjacent to the through-hole is provided with a slag inlet, a rotating part, and a pushing part, and the other end of the slag discharging pipe is provided with a slag outlet, the rotating part is rotatably connected to the bottom of the juice discharging bucket, the slag inlet is connected to the slag outlet, and the pushing part is disposed adjacent to one end of the transmission shaft; a pushing block extends outward from one end of the slag discharging pipe to form the pushing part, an arc-shaped avoidance part corresponding to the outer circumference of the transmission shaft is provided on the pushing block and is close to the outer circumference of the transmission shaft; the pushing block is provided with a rotating part, the slag inlet is located on one side of the pushing block, and the slag outlet is located on one side of the through-hole, the rotating part is connected to the bottom of the juice discharging bucket located on the outer circumference of the through-hole, and the rotating part is located between the slag outlet and the through-hole.

2. The juice discharging bucket structure of a food processing machine according to claim 1, further comprising a shaft fixing assembly, wherein the rotating part is a shaft, the shaft fixing assembly is connected to the bottom of the juice discharging bucket adjacent to the through-hole, the shaft fixing assembly is provided with two shaft holes, and the two ends of the shaft extend into the corresponding shaft holes, respectively.

3. The juice discharging bucket structure of a food processing machine according to claim 2, wherein the shaft fixing assembly comprises an upper fixing part and a lower fixing part, the upper fixing part is provided with two upper notches, and the lower fixing part is provided with two lower notches, the lower fixing part is fixed at the bottom of the juice discharging bucket adjacent to the through-hole, the upper fixing part is fixed on the lower fixing part, and the upper fixing part and lower fixing part together form the shaft hole.

4. The juice discharging bucket structure of a food processing machine according to claim 3, wherein a connecting column with a connecting screw hole is provided on the juice discharging bucket adjacent to the through-hole, a lower through-hole is opened at a position, corresponding to the connecting screw hole, on the lower fixing part, an upper through-hole is opened at a position, corresponding to the lower through-hole, on the upper fixing part, and a connecting screw sequentially passing through the upper through-hole and lower through-hole is connected to the connecting screw hole.

5. The juice discharging bucket structure of a food processing machine according to claim 1, wherein a first buckle part is further provided on the slag discharging pipe and the first buckle part is located between the slag inlet and the slag outlet, and a second buckle part is provided at a position, corresponding to the first buckle part, on the bottom of the juice discharging bucket, and the first buckle part is snap-fitted with the second buckle part.

6. The juice discharging bucket structure of a food processing machine according to claim 5, wherein a first block is provided on the slag discharging pipe, the first block forms the first buckle part, the juice discharging bucket is provided with a detachable buckle base, a second block is provided on the buckle base to form the second buckle part, and the ends of the first block and second block, where the first block abuts against the second block, are an arc-shaped surface.

7. The juice discharging bucket structure of a food processing machine according to claim 1, further comprising a sealing part, a sealing part groove is provided adjacent to the slag inlet of slag discharging pipe, the sealing part is embedded in the sealing part groove and abuts against the periphery of the slag outlet of juice discharging bucket.

8. The juice discharging bucket structure of a food processing machine according to claim 5, further comprising a sealing part, a sealing part groove is provided adjacent to the slag inlet of slag discharging pipe, the sealing part is embedded in the sealing part groove and abuts against the periphery of the slag outlet of juice discharging bucket.

9. The juice discharging bucket structure of a food processing machine according to claim 6, further comprising a sealing part, a sealing part groove is provided adjacent to the slag inlet of slag discharging pipe, the sealing part is embedded in the sealing part groove and abuts against the periphery of the slag outlet of juice discharging bucket.

10. The juice discharging bucket structure of a food processing machine according to claim 9, wherein the sealing part is a silicone part comprising a middle blocking block and a surrounding block, the surrounding block is disposed around the middle blocking block, a gap is provided between the surrounding block and the middle blocking block, the surrounding block is embedded in the sealing part groove, and the middle blocking block abuts against the slag outlet.
